(19) United States
(12) Patent Application Publication
(10) Pub. No.: US 2020/0292884 A1
(43) Pub. Date: Sep. 17, 2020

(54) BACKLIGHT ASSEMBLY AND LIQUID CRYSTAL DISPLAY DEVICE INCLUDING THE SAME

(71) Applicant: Samsung Display Co., Ltd., Yongin-si (KR)

(72) Inventors: YONG JUN LEE, HWASEONG-SI (KR); YU BIN KIM, SUWON-SI (KR); MAN SOO KIM, ASAN-SI (KR)

(21) Appl. No.: 16/726,485

(22) Filed: Dec. 24, 2019

(30) Foreign Application Priority Data
Mar. 14, 2019 (KR) 10-2019-0029542

(51) Int. Cl. G02F 1/1335

(52) U.S. Cl. CPC G02F 1/133608; G02F 2001/133607; G02F 1/133606; G02F 1/133605

(57) ABSTRACT

A backlight assembly includes an optical member, a bottom chassis that includes a bottom surface on which the optical member is disposed, a first sidewall portion that protrudes from a first side of the bottom surface in a first direction, and a first support portion that protrudes from the first sidewall portion in a second direction that intersects the first direction, and an assembly member that includes a body, and, protruding from the body, a first protrusion and a second protrusion. The second protrusion overlaps an outer surface of the first support portion.

### CROSS REFERENCE TO RELATED APPLICATIONS

This application claims priority under 35 U.S.C. § 119 from, and the benefit of, Korean Patent Application No. 10-2019-0029542, filed on Mar. 14, 2019 in the Korean Intellectual Property Office, the contents of which are herein incorporated by reference in their entirety.

### BACKGROUND

### 1. Technical Field

Embodiments of the present disclosure are directed to a backlight assembly and a liquid crystal display device that includes the same.

### 2. Discussion of the Related Art

A liquid crystal display device receives light from a backlight assembly and displays an image. Some backlight assemblies include a light source and a light guide plate. The light guide plate receives light from the light source and guides the light toward a display panel. In some products, light received from the light source is white light, and the white light is filtered using a color filter disposed in the display panel to impart a color.

Recently, wavelength conversion films have been developed to improve image quality, such as color reproducibility, etc., of a liquid crystal display device. A blue light source is usually used as the light source, and the wavelength conversion film is disposed on the light guide plate to convert light into white light. The wavelength conversion film can be combined together with an optical film which improves luminance by controlling the optical characteristics of light propagating through the wavelength conversion film.

A liquid crystal display device also includes fixing members such as a lower accommodation container, a light guide plate fixing portion, and a mold frame, which couple the light guide plate, the optical film, the display panel, etc. However, when the light guide plate, the optical film, and the display panel are coupled using different fixing members, an assembling process, an assembling time, and a manufacturing cost increases. In addition, this process is not used to manufacture a slim display device that has a three-surface frameless structure or a moldless structure, etc.

### SUMMARY

Embodiments of the present disclosure provide a display device that can prevent movement of a backlight assembly by integrating a plurality of fixing members into one unit.

Embodiments of the present disclosure also provide a display device that can prevent light leakage through a bendable portion of a fixing member.

According to an embodiment of the present disclosure, a backlight assembly includes an optical member, a bottom chassis that includes a bottom surface on which the optical member is disposed, a first sidewall portion that protrudes in a first direction from a first side of the bottom surface, and a first support portion that protrudes from the first sidewall portion in a second direction that intersects the first direction, and an assembly member that includes a body, and, protruding from the body, a first protrusion and a second protrusion. The second protrusion overlaps an outer surface of the first support portion.

In an exemplary embodiment, the body includes a first upper surface portion and a first side surface portion that extends downward from the first upper surface portion. The first upper surface portion includes a corner portion that forms a right angle in a plan view, a peripheral portion that is spaced apart from the corner portion, and has a first side and a second side that connect the corner portion and the peripheral portion.

In an exemplary embodiment, the first protrusion extends from a portion of the first side and a portion of the second side and includes a second upper surface portion and a second side surface portion that extends downward from the second upper surface portion.

In an exemplary embodiment, the first upper surface portion is coplanar with the second upper surface portion, and the first side surface portion is coplanar with the second side surface portion.

In an exemplary embodiment, the optical member includes a plurality of corner portions, and each corner portion of the optical member is in contact with the first side surface portion and the second side surface portion.

In an exemplary embodiment, the assembly member further includes a third protrusion that extends from the second side surface portion of the first protrusion.

In an exemplary embodiment, a lower surface of the third protrusion is in contact with an upper surface of the optical member.

In an exemplary embodiment, the first sidewall portion of the bottom chassis further includes a latch stepped portion and the second side surface portion of the first protrusion includes a coupling hole that couples to the latch stepped portion.

In an exemplary embodiment, the assembly member includes a second sidewall portion that extends upward from the peripheral portion.

In an exemplary embodiment, the second protrusion extends from the second sidewall portion parallel to the second sidewall portion of the first protrusion.

In an exemplary embodiment, the body includes a first lower surface portion opposite to the first upper surface portion, and the backlight assembly further includes a first adhesive member disposed between the first lower surface portion and the first support portion.

In an exemplary embodiment, the backlight assembly further includes a spacer tape disposed on the first support portion. Both ends of the spacer tape are disposed along boundaries between the body, and the first protrusion and the second protrusion.

In an exemplary embodiment, the optical member includes a light guide plate, a wavelength conversion layer disposed on the light guide plate, and a passivation layer that covers the wavelength conversion layer.

In an exemplary embodiment, the backlight assembly further includes an optical films disposed on the optical member.

In an exemplary embodiment, the optical film includes at least one of a diffusion layer, a prismatic pattern layer, or a reflective polarizing layer.

According to an embodiment of the present disclosure, a display device includes a display panel, and a backlight assembly disposed on one surface of the display panel and that provides light to the display panel. The backlight assembly includes an optical member and an assembly member that includes a body that includes a first upper surface portion, a first side surface portion that extends downward from the first upper surface portion, and a first protrusion and a second protrusion that protrude from the body. The first protrusion includes a second upper surface portion and a second side surface portion that extends downward from the second upper surface portion, and the optical member comprises a plurality of corner portions, and the corner portions of the optical member are disposed in contact with the first side surface portion and the second side surface portion.

In an exemplary embodiment, the first protrusion extends from a portion of the first side and a portion of the second side, and the first upper surface portion includes a corner portion that forms a right angle in a plan view, a peripheral portion spaced apart from the corner portion, and a first side and a second side that connect the corner portion and the peripheral portion.

In an exemplary embodiment, the first upper surface portion is coplanar with the second upper surface portion, and the first side surface portion is coplanar with the second side surface portion.

In an exemplary embodiment, the backlight assembly further comprises a bottom chassis that includes a bottom surface on which the optical member is disposed, a first sidewall portion that protrudes in a first direction from a side of the bottom surface, and a first support portion that protrudes from the first sidewall portion in a second direction that intersects with the first direction, and the second protrusion overlaps an outer surface of the first support portion.

In an exemplary embodiment, the assembly member includes a second sidewall portion that extends upward from the peripheral portion, where the second sidewall portion is in contact with an edge of the display panel.

### BRIEF DESCRIPTION OF THE DRAWINGS

FIG. 1 is an exploded perspective view of a display device according to an exemplary embodiment.

FIGS. 2A and 2B are perspective views of an assembly member of FIG. 1.

FIG. 3A is a plan view of an assembly member.

FIG. 3B is a side view of an assembly member.

FIGS. 4 to 11 illustrate a method of assembling a display device using the assembly member of FIGS. 2A to 3B.

FIG. 12 is a perspective view of an assembly member according to another exemplary embodiment of FIG. 1.

FIG. 13A is a plan view of an assembly member according to another exemplary embodiment.

FIG. 13B is a side view of an assembly member according to another exemplary embodiment;

FIG. 14 is a perspective view of one corner of a bottom chassis according to another exemplary embodiment.

FIG. 15 is a cross-sectional view of a display device taken along line II-II′ of FIG. 10 according to another exemplary embodiment.

### DETAILED DESCRIPTION OF EXEMPLARY EMBODIMENTS

Embodiments of the present disclosure will now be described more fully hereinafter with reference to the accompanying drawings, in which exemplary embodiments of the disclosure are shown. Embodiments of this disclosure may, however, take different forms and should not be construed as limited to exemplary embodiments set forth herein.

It will also be understood that when a layer is referred to as being “on” another layer or substrate, it can be directly on the other layer or substrate, or intervening layers may also be present. The same reference numbers may indicate the same components throughout the specification.

Hereinafter, embodiments of the present disclosure will be described with reference to the attached drawings.

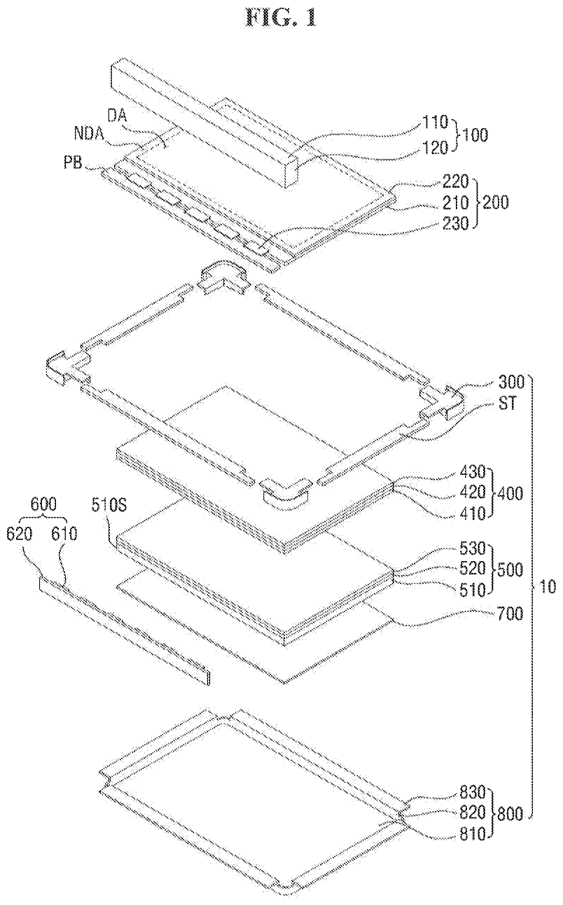

FIG. 1 is an exploded perspective view of a display device according to an exemplary embodiment.

Referring to FIG. 1, a display device 1 according to an exemplary embodiment of the present disclosure includes a top chassis 100, a display panel 200, and a backlight assembly 10. The backlight assembly 10 includes an assembly member 300, an optical member 500, an optical film 400, a light source module 600, a reflective sheet 700, a bottom chassis 800, etc. The display panel 200 includes one of various light receiving display panels, such as a liquid crystal display panel, an electrowetting display panel, an electrophoretic display panel, or a microelectromechanical system display panel (MEMS display panel), etc. Hereinafter, an embodiment in which the display panel 200 is a liquid crystal display panel will be described as a non-limiting example.

According to an embodiment, the display panel 200 displays an image by adjusting an arrangement of liquid crystals that receive light from the backlight assembly 10 and refract the light in different patterns. The display panel 200 includes a thin film transistor substrate 210 on which a thin film transistor is formed, a color filter substrate 220 that faces the thin film transistor substrate 210, and a liquid crystal layer interposed between the thin film transistor substrate 210 and the color filter substrate 220.

According to an embodiment, the display panel 200 further includes a driving chip, a driving circuit film 230, and a printed circuit board PB. The driving circuit film 230 is bent to electrically connect the display panel 200 and the printed circuit board PB. One end of the driving circuit film 230 is connected to one surface of the thin film transistor substrate 210, and the other end thereof is connected to the printed circuit board PB.

According to an embodiment, the printed circuit board PB outputs signals to the display panel 200 or receives signals from the display panel 200 through the driving circuit film 230. The printed circuit board PB is illustrated in FIG. 1 as being disposed on the same plane as the display panel 200, but may be disposed at various other positions according to a structure of the liquid crystal display device 1. As the driving circuit film 230 is bent, the printed circuit board PB is disposed on a lower or side surface of the backlight assembly 10.

According to an embodiment, the driving chip receives external signals and generates driving signals that drive the display panel 200. The external signals are received from the printed circuit board PB. The external signals include a video signal, various control signals, a driving voltage, etc. The driving chip may be mounted on the driving circuit film 230, the printed circuit board PB, or the thin film transistor substrate 210.

According to an embodiment, the top chassis 100 includes an edge 110 that surrounds an edge of a lower long side of the display panel 200 and a top chassis sidewall 120 that extends toward the bottom chassis 800 from an outer perimeter of the edge. According to an exemplary embodiment, the top chassis 100 has a rectangular parallelepiped shape in which two surfaces that include a long side are omitted. The top chassis sidewall 120 couples to a sidewall 820 of the bottom chassis 800 using coupling portions such as a bolt and a nut, but embodiments of the present disclosure are not limited thereto.

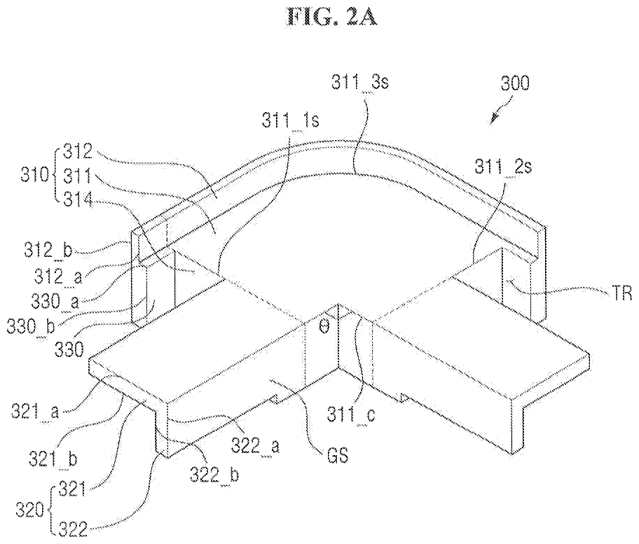

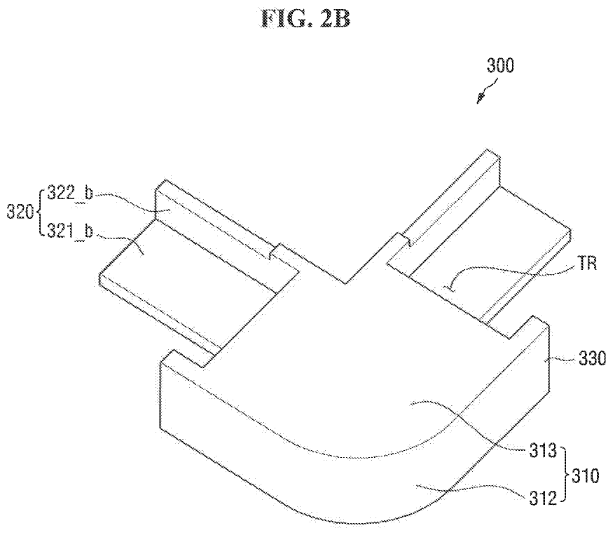

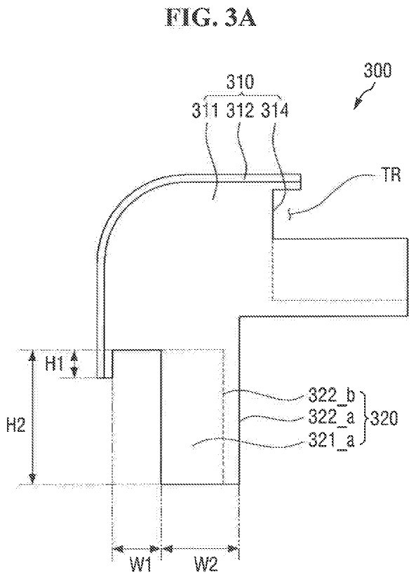

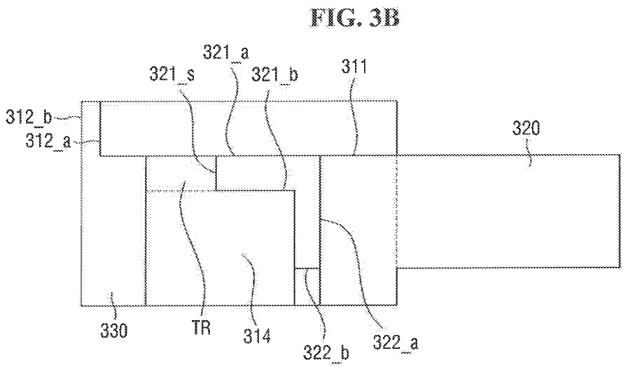

According to an embodiment, the assembly member 300 guides edges of the display panel 200 and the optical member 500 and thus is fixedly coupled to the bottom chassis 800. The assembly member 300 has a groove that couples to a panel support plate 830 of the bottom chassis 800 to be described below or attaches to the panel support plate 830 using double-sided tape. The assembly member 300 will be described in detail with reference to FIGS. 2 and 3, below.

According to an embodiment, a spacer tape ST is disposed between an edge region of the display panel 200 and the panel support plate 830. Here, the spacer tape ST has a thickness sufficient to flatly support the display panel 200 supported by the assembly member 300 and the panel support plate 830. The spacer tape ST includes a buffer member, a first adhesive layer disposed on one surface of the buffer member that attaches the buffer member and the display panel 200, and a second adhesive layer disposed on the other surface of the buffer member that attaches the buffer member to the bottom chassis 800.

According to an embodiment, the backlight assembly 10 is disposed on a rear of the display panel 200. Here, a front of the display panel 200 refers to direction in which an image is displayed, and the rear of the display panel 200 refers to a direction opposite from the front direction. Hereinafter, a front or a front surface of an element refers to a direction in which the image is displayed, and a rear or a rear surface of the element refers to a direction opposite to the front direction.

According to an embodiment, the bottom chassis 800 has a space that accommodates the optical member 500, the optical film 400, the light source module 600, and the reflective sheet 700, etc. Specifically, the bottom chassis 800 includes a bottom surface 810, the sidewall 820 that protrudes upward along an edge of the bottom surface 810, and the support portion 830 that extends outward from the sidewall 820 parallel to the bottom surface 810. The support portion 830 does not overlap the bottom surface 810 but overlaps the edge region of the display panel 200.

According to an embodiment, the optical member 500 includes a light guide plate 510, a wavelength conversion layer 520 disposed on the light guide plate 510, and a passivation layer 530 disposed on the wavelength conversion layer 520. The light source module 600 faces one side of the optical member 500. For example, the light source module 600 is disposed adjacent to a light incidence surface 510s of the light guide plate 510 of the optical member 500. The light source module 600 includes a plurality of point light sources or linear light sources. The point light source is a light-emitting diode (LED) light source 610. A plurality of LED light sources 610 are mounted on a printed circuit board 620. The LED light source 610 emits blue light.

In an exemplary embodiment, the LED light source 610 is a top-emitting LED that emits light through a top surface thereof. In this case, the printed circuit board 620 is disposed on an inner surface of the sidewall 820 of the bottom chassis such that the LEDs 610 emit light in a direction away from the sidewall 820 and into the light incidence surface 510s of the light guide plate 510.

According to an embodiment, the blue light emitted from the LED light sources 610 is incident into the light guide plate 510. The light guide plate 510 guides light and emits the light through an upper surface or a lower surface of the light guide plate 510. The wavelength conversion layer 520 converts some of the blue light received from the light guide plate 510 into light having other wavelengths, such as green and red. The converted red and green light is emitted upward together with unconverted blue light toward the display panel 200.

According to an embodiment, the reflective sheet 700 is disposed inside the bottom chassis 800. For example, the reflective sheet 700 is disposed on an inner surface of the bottom plate 810 of the bottom chassis 800. However, embodiments of the present disclosure are not limited thereto, and the reflective sheet 700 can be disposed along inner surfaces of the bottom plate 810 and the sidewall 820 of the bottom chassis 800.

According to an embodiment, the reflective sheet 700 is disposed below the light guide plate 510 on a rear surface thereof and reflects light that has propagated out of the lower surface 510b of the light guide plate 510 back into the light guide plate 510 again. The reflective sheet 700 may be made of a plastic or a reflective metal, etc.

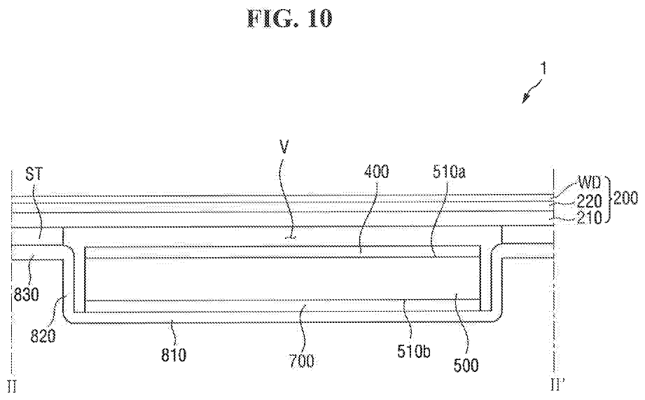

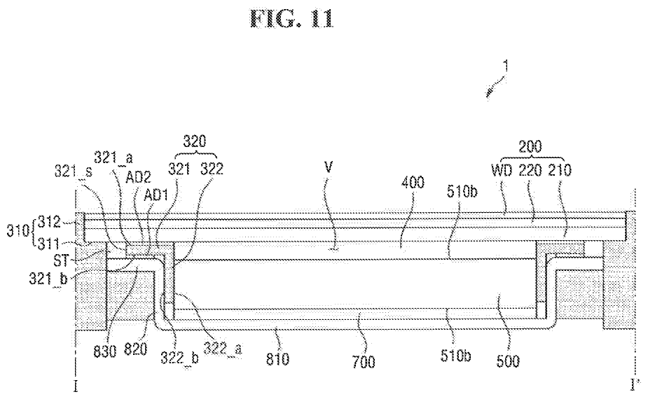

According to an embodiment, the light guide plate 510 guides the propagation of light. The light guide plate 510 has an overall polygonal plate shape. A planar shape of the light guide plate 510 may be rectangular, but embodiments are not limited thereto. In an exemplary embodiment, the light guide plate 510 may have a parallelepiped shape with a rectangular planar shape and may have an upper surface 510a, a lower surface 510b, shown in FIGS. 10-11, and four side surfaces 510S.

In an exemplary embodiment, each of the upper surface 510a and the lower surface 510b of the light guide plate 510 are disposed on one plane. The plane on which the upper surface 510a is disposed is substantially parallel to the plane on which the lower surface 510b is disposed, and thus, the light guide plate 510 has an overall uniform thickness. However, embodiments of the present disclosure are not limited thereto, and the upper surface 510a or the lower surface 510b may each have a plurality of planes, or a plane of the upper surface 510a may intersect with a plane of the lower surface 510b. For example, the light guide plate may have a wedge shape in which a thickness of the light guide plate 510 decreases from one side surface, such as a light incident surface, to the other side surface, such as an opposite surface, opposite to the one side surface. Furthermore, the lower surface 510b may gradually incline upwards from near the side surface, such as the light incident surface, to the other side surface, such as the opposite surface, for a predetermined distance, so that the thickness decreases. Then, the upper surface has a flat shape.

According to an embodiment, the planes of the upper surface 510a and the lower surface 510b each form an angle of about 90° with a plane of each side surface 510s. In some exemplary embodiments, the light guide plate 510 has an inclined surface between the upper surface 510a and one side surface 510s and or between the lower surface 501b and one side surface 510s. Hereinafter, an embodiment will be described in which the upper surface and the side surface meet directly to form an angle of about 90° without an inclined surface.

According to an embodiment, a scattering pattern is disposed on the lower surface 510b of the light guide plate 510. The scattering pattern changes a propagation direction of light inside the light guide plate 510 through total reflection and outputs the light out of the light guide plate 510.

In an exemplary embodiment, the scattering pattern is provided as a separate layer or pattern. For example, a pattern layer that includes a protrusion pattern or a concave groove pattern is formed, or a print pattern is formed on the lower surface 510b of the light guide plate 510 to function as the scattering pattern.

In another embodiment, the scattering pattern is a pattern of a surface of the light guide plate 510 itself. For example, concave grooves are formed on the lower surface 510b of the light guide plate 510 to function as the scattering pattern.

According to an embodiment, a pattern density of the scattering pattern varies according to regions. For example, a region adjacent to the light incidence surface having a relatively high light intensity has a low pattern density, and a region adjacent to the opposite surface having a relatively low light intensity has a high pattern density.

According to an embodiment, the light guide plate 510 is made of a light transmissive material, such as glass, quartz, or a polymer, etc., such that light is efficiently guided. For example, the polymer includes a material having a predetermined refractive index, such as an acrylic resin such as polymethyl methacrylate (PMMA) or polycarbonate (PC).

According to an embodiment, the wavelength conversion layer 520 is disposed on an upper surface of the light guide plate 510. The wavelength conversion layer 520 converts a wavelength of at least a portion of the incident light. The wavelength conversion layer 520 includes a binder layer and wavelength conversion particles dispersed in the binder layer. The wavelength conversion layer 520 further includes scattering particles dispersed in the binder layer in addition to the wavelength conversion particles.

According to an embodiment, the binder layer is made of one or more various resin compositions, which are generally referred to as a binder, as a medium in which the wavelength converting particles are dispersed. However, embodiments of the present disclosure are not limited thereto, and in other embodiments, a medium referred to as the binder layer may include additional other functions or component materials, etc., as long as the medium can bind the wavelength conversion particles or the scattering particles.

According to an embodiment, the wavelength conversion particles convert a wavelength of incident light. For example, the wavelength conversion particles may be quantum dots (QDs), fluorescent materials, or phosphorescent materials. QDs will be described in detail as an example of wavelength conversion particles. A QD has a crystal structure with a size of few nanometers, includes hundreds to thousands of atoms, and exhibits a quantum confinement effect in which an energy band gap increases with decreasing size of the QD. When light having a wavelength with energy higher than that of the band gap is incident on a QD, the QD absorbs the light and transitions to an excited state, and decays back to a ground state by emitting light having a specific wavelength. The emitted light has a wavelength whose energy corresponds to the band gap. The size and composition of a QD can be adjusted to adjust emission characteristics due to the quantum confinement.

For example, according to an embodiment, a QD include at least one of a II-VI group compound, a II-V group compound, a III-VI group compound, a III-V group compound, a IV-VI group compound, or a II-IV-V group compound.

According to an embodiment, a QD includes a core and a shell that overcoats the core. However, embodiments of the present disclosure are not limited thereto. For example, the core includes at least one of CdS, CdSe, CdTe, ZnS, ZnSe, ZnTe, GaN, GaP, GaAs, GaSb, AlN, AlP, AlAs, AlSb, InP, InAs, InSb, SiC, Ca, Se, In, P, Fe, Pt, Ni, Co, Al, Ag, Au, Cu, FePt, Fe₂O₃, Fe₃O₄, Si, or Ge, and the shell includes at least one of ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe, or PbTe.

According to an embodiment, there are a plurality of different types of wavelength conversion particles that convert incident light into light of different wavelengths. For example, the wavelength conversion particles include first wavelength conversion particles that convert incident light having a specific wavelength into light having a first wavelength, and second wavelength conversion particles that convert incident light having the specific wavelength into light having a second wavelength. In an exemplary embodiment, light emitted from the light source 610 and incident on the wavelength conversion particles is blue light, the first wavelength is a green wavelength, and the second wavelength is a red wavelength. For example, the blue wavelength has a peak wavelength of from 420 nm to 470 nm, the green wavelength has a peak wavelength of from 520 nm to 570 nm, and the red wavelength has a peak wavelength of from 620 nm to 670 nm. However, embodiments of the present disclosure are not limited to the disclosed peak wavelengths, and the blue, green, and the red wavelengths include all wavelength ranges capable of being perceived as blue, green, or red light.

In an exemplary embodiment, when blue light incident on the wavelength conversion layer 520 passes through the wavelength conversion layer 520, a portion of the blue light incident on the first wavelength conversion particles is converted into and emitted as green light. Another portion of the blue light incident on the second wavelength conversion particles is converted into and emitted as red light. The remaining portion of the blue light is emitted from the wavelength conversion layer 520 without being incident on the first and second wavelength conversion particles. Accordingly, the light emitted from the wavelength conversion layer 520 includes the remaining portion of blue along with the green light and the red light. A ratio between different colored emitted light can be appropriately adjusted to display white light or different color light. Light converted by the wavelength conversion layer 520 has a sharp spectrum that is concentrated within a specific, narrow wavelength range and has a narrow full-width. Therefore, when light having such a spectrum is filtered by a color filter to impart a color, color reproducibility is improved.

However, unlike an above-described exemplary embodiment, in another embodiment, incident light is other short-wavelength light, such as ultraviolet light, and the wavelength conversion layer 520 includes three types of wavelength conversion particles that convert the incident light into blue light, green light, and red light, thereby emitting white light.

According to an embodiment, the wavelength conversion layer 520 further includes scattering particles. The scattering particles are not quantum dot particles and have no wavelength conversion function. The scattering particles scatter incident light so that more incident light is incident on the wavelength conversion particles. In addition, the scattering particles uniformly control an emission angle of light for each wavelength. Specifically, when a portion of light is incident on the wavelength conversion particles and then is converted and emitted as another wavelength, an emission direction of the emitted portion thereof is random. When scattering particles are not present in the wavelength conversion layer 520, green light and red light emitted by the wavelength conversion particles have emission characteristics, but blue light that did not collide with the wavelength conversion particles does not have emission characteristics. Thus, a ratio of blue, green, and red wavelengths in the light will vary according to emission angles. The scattering particles impart scattering characteristics to blue light, thereby adjusting the light emission angles for each wavelength. TiO₂ or SiO₂, etc., can be used as the scattering particles.

According to an embodiment, the passivation layer 530 is disposed on the wavelength conversion layer 520. The passivation layer 530 prevents permeation of impurities such as moisture or oxygen. The passivation layer 530 is made of an inorganic material. For example, the passivation layer 530 includes at least of silicon nitride, aluminum nitride, zirconium nitride, titanium nitride, hafnium nitride, tantalum nitride, silicon oxide, aluminum oxide, titanium oxide, tin oxide, cerium oxide or silicon oxynitride, or is formed as a metallic thin film that can transmit light. In an exemplary embodiment, the passivation layer 530 is made of silicon nitride.

According to an embodiment, the passivation layer 530 completely overlaps the wavelength conversion layer 520, covers an upper surface of the wavelength conversion layer 520, and further extends outward from the wavelength conversion layer 520 to also cover side surfaces of the wavelength conversion layer 520. The passivation layer 530 contacts the upper and side surfaces of the wavelength conversion layer 520. The passivation layer 530 extends to the upper surface of an edge of the light guide plate 510 exposed by the wavelength conversion layer 520, and thus, a portion of an edge of the passivation layer 530 is in direct contact with the upper surface of the light guide plate 510. In an exemplary embodiment, a side surface of the passivation layer 530 is aligned with a side surface of the light guide plate 510.

According to an embodiment, the wavelength conversion layer 520 is sealed by the passivation layer 530, etc., thereby preventing degradation of the wavelength conversion layer 520. In addition, the wavelength conversion layer 520 and a sealing structure thereof reduce a manufacturing cost and a thickness of the optical member 500 as compared with a wavelength conversion layer provided as a separate film.

According to an embodiment, an optical film 400 is disposed between the optical member 500 and the display panel 200. The optical film 400 is disposed on an upper surface of the optical member 500 and diffuses and condenses light emitted from the optical member 500.

According to an embodiment, a plurality of optical films 400 are provided. The plurality of optical films 400 are stacked to overlap and complement each other. The optical film 400 includes a first film 410, a second film 420, and a third film 430 integrated with each other. In an exemplary embodiment, the first film 410 is a microlens pattern layer or a diffusion layer, the second film 420 is a prismatic pattern layer, and the third film 430 includes a reflective polarizing layer.

According to an embodiment, the plurality of optical films 400 will be described in more detail. First, the first film 410 is disposed between the optical member 500 and the second film 420 and disperses light received from the optical member 500 to prevent the incident light from being partially concentrated. The second film 420 includes a triangular prism arrangement on one surface thereof and condenses the light diffused by the first film 410 in a direction perpendicular to the display panel 200. Finally, to improve luminance characteristics, the third film 430 transmits light received from the second film 420 that oscillates in the first direction and reflects the light received from the second film 420 that oscillates in a second direction perpendicular to the first direction.

According to an exemplary embodiment, the optical member 500 and the optical film 400 are coupled to each other by an optical member coupling layer. The optical member coupling layer is a film that has adhesive characteristics on both an upper surface and a lower surface thereof. For example, the optical member coupling layer may be a pressure sensitive adhesive (PSA), an optical clear adhesive (OCA), or an optical clear resin OCR. The optical member coupling layer includes one or more of acrylic resin or silicone resin, etc.

FIGS. 2A and 2B are perspective views of an assembly member of FIG. 1. FIG. 3A is a plan view of an assembly member. FIG. 3B is a side view of an assembly member.

Referring to FIGS. 2A, 2B, 3A, and 3B, according to an embodiment, the assembly member 300 includes a body 310, two first protrusions 320, and two second protrusions 330. The body 310 of the assembly member 300 has one corner which forms a right angle. Each first protrusion 320 extends from one side of the body 310 and has a guide surface GS formed as a right angle θ in a plan view that guides the four corners of the optical member 500. For clarity of illustration, only one of each of the first protrusions 320 and second protrusions 330 is labeled. To prevent the spacer tape ST from detaching, each second protrusion 330 extends from one side of the body 310 in directions perpendicular to each other and perpendicular to the extension direction of the first protrusion 320.

According to an embodiment, the body 310 of the assembly member 300 includes an upper surface portion 311, a sidewall portion 312, a lower surface portion 313, and a side surface portion 314.

According to an embodiment, the upper surface portion 311 of the body 310 includes a support portion 311_c which is formed as a right angle in a plan view and a peripheral portion 311_3s disposed to be spaced apart from the support portion 311_c and may have a first side 311_1s and a second side 311_2s which connect the support portion 311_c and the peripheral portion 311_3s. According to an exemplary embodiment, the body 310 has a rectangular shape in a plan view, the support portion 311_c is a region bent to an inner side of the rectangular shape, and the peripheral portion 311_3s has a chamfered shape between two intersecting sides. The support portion 311_c is in contact with a corner of the optical member 500 and supports the optical member 500 together with a side surface portion 322 of the first protrusion 320 to be described below. However, embodiments of the present disclosure are not limited thereto, and in other embodiments, a shape of the supporting portion 311_c can vary according to a shape of the corner of the optical member 500 disposed adjacent thereto. For example, the supporting portion 311_c may have a polygonal shape or an elliptical shape.

According to an embodiment, the sidewall portion 312 of the body 310 extends upward from the peripheral portion 311_3s along the peripheral portion 311_3s. The sidewall portion 312 has an inner side surface 312_a and an outer side surface 312_b opposite to the inner side surface 312_a. According to an exemplary embodiment, the sidewall portion 312 forms a rounded corner in a plan view. To support the display panel 200, the inner side surface 312_a is in contact with a corner of the display panel 200. When the display panel 200 has a frameless structure, the outer side surface 312_b forms an exterior of a product. However, embodiments of the present disclosure are not limited thereto, and in other embodiments, a shape of the sidewall portion 312 can vary according to a shape of the corner of the display panel 200 disposed adjacent thereto. For example, the sidewall portion 312 may have a polygonal shape or an elliptical shape. A height of the sidewall portion 312 is greater than or equal to a thickness of the display panel 200 disposed adjacent thereto.

According to an embodiment, the side surface portion 314 of the body 310 extends downward from the upper surface portion 311. A height of the side surface portion 314 is less than or equal to a height of the bottom chassis 800 coupled to the assembly member 300. According to an exemplary embodiment, the bottom surface 810 of the bottom chassis 800 has a rectangular shape in a plan view. The sidewall 820 that extends upward from the bottom surface 810 is not formed in the four corner regions of the bottom chassis 800. The side surface portion 314 of the body 310 is in contact with the sidewall 820 of the bottom chassis 800.

According to an embodiment, the lower surface portion 313 of the body 310 is a surface opposite to the upper surface portion 311. According to an exemplary embodiment, the assembly member 300 coupled to the bottom chassis 800 is coupled to an outer case, and the lower surface portion 313 is in contact with one surface of the case. However, embodiments of the present disclosure are not limited thereto, and in other embodiments, the lower surface portion 313 is omitted. In this case, the body 310 is hollow.

According to an embodiment, each of the first protrusions 320 of the assembly member 300 includes an upper surface portion 321 and a side surface portion 322.

According to an embodiment, each of the upper surface portions 321 of the first protrusions 320 respectively extend from a portion of the first side 311_1s and a portion of the second side 311_2s of the body 310. Each upper surface portion 321 has a first surface 321_a and a second surface 321_b opposite to the first surface 321_a. The first surface 321_a forms one coplanar surface with the upper surface portion 311. The first surface 321_a and the upper surface portion 311 of the body 310 are in contact with a lower surface of the display panel 200. The second surface 321_b is in contact with an upper surface of the support portion 830 of the bottom chassis 800. The second surface 321b couples to the support portion 830 of the bottom chassis 830 using a double-sided tape.

According to an embodiment, the side surface portion 322 of the first protrusion 320 extends downward from the upper surface portion 321, parallel to the extension direction of the second protrusions 330. The side surface portion 322 has a third surface 322_a and a fourth surface 322_b opposite to the third surface 322_a. The third surface 322_a form one coplanar surface with the surface of the support portion 311_c. The third surface 322_a and the surface of the support portion 311_c are in contact with and overlap a corner surface of the optical member 500. The fourth surface 322_b is in contact with and overlaps a surface of the sidewall 820 of the bottom chassis 800. The fourth surface 322_b couples to the sidewall 820 of the bottom chassis 830 using a double-sided tape.

According to an embodiment, each second protrusion 330 of the assembly member 300 extends from the upper surface portion 311 and the sidewall portion 312 of the body 310 at the first side 311_1s and the second side 311_2s and is parallel to the side surface portion 322 of the second protrusion 320. In the assembly member 300, trench regions TR are formed in spaces between the body 310, and the first protrusion 320 and the second protrusion 330 at the first side 311_1s and the second side 311_2s. A width W1 of the trench region TR is less than a width W2 of the upper surface portion 321 of the first protrusion 320, and a depth H1 of the trench region TR is less than a length H2 of the upper surface portion 321 of the first protrusion 320. The width W1 and the depth H1 of the trench region TR can be freely varied within the range to prevent the spacer tape ST disposed adjacent thereto from detaching from the support portion 830 of the bottom chassis 800.

According to an embodiment, the second protrusion 330 has a fifth surface 330_a and a sixth surface 330_b extending downward from the fifth surface 330_a. The fifth surface 330_a of the second protrusion 330 forms one coplanar surface with the upper surface portion 311. The fifth surface 330_a, the first surface 321_a, and the upper surface portion 311 of the body 310 are in contact with the lower surface of the display panel 200. The sixth surface 330_b of the second protrusion 330 is in contact with and overlaps a surface of the sidewall 820 of the bottom chassis 800.

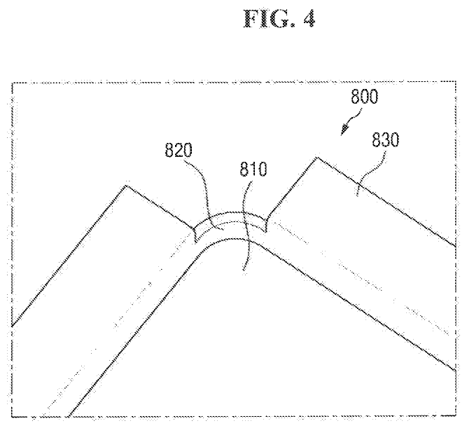

FIGS. 4 to 11 illustrate a method of assembling a display device using an assembly member of FIGS. 2A to 3B.

Referring to FIGS. 4 to 11, according to an embodiment, a display device 1 has a structure in which a bottom chassis 800, a reflective sheet 700, an optical member 500, an assembly member 300, an optical film 400, and a display panel 200 are sequentially stacked. In a method of assembling the display device 1, first the bottom chassis 800 is provided. According to an exemplary embodiment, in the bottom chassis 800, a bottom surface 810 of the bottom chassis 800 has a rectangular shape in a plan view. A sidewall 820 that protrudes upward from the bottom surface 810 protrudes higher along the sides of the bottom chassis than in the four corner regions of the bottom chassis 800. The bottom chassis 800 includes a support portion 830 that extends outward from the sidewall 820 and parallel to the bottom surface 810.

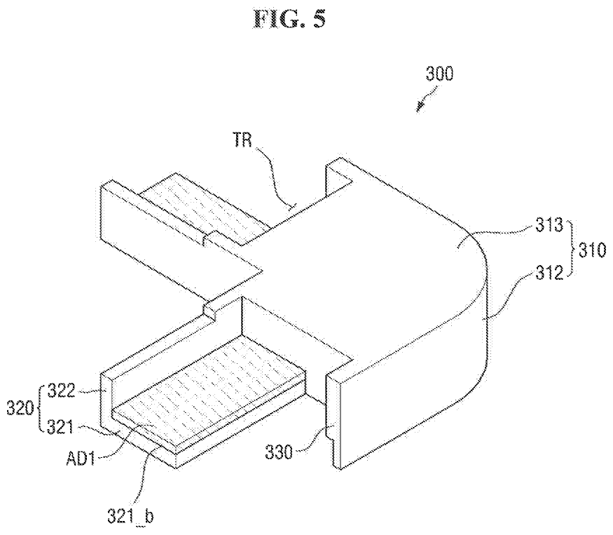

Referring to FIG. 5, according to an embodiment, an adhesive member AD1 that couples the assembly member 300 to the bottom chassis 800 is attached to lower surfaces of the assembly member 300. An upper surface portion 321 of the assembly member 300 has a first surface 321_a and a second surface 321_b opposite to the first surface 321_a. The second surface 321_b is disposed in contact with an upper surface of the support portion 830 of the bottom chassis 800. The second surface 321_b couples to the support portion 830 of the bottom chassis 800 using the adhesive member AD1 such as a double-sided tape. However, embodiments of the adhesive member AD1 are not limited thereto, and in other embodiments, the adhesive member AD1 is an adhesive layer applied onto the second surface 321_b. At least a portion of the adhesive member AD1 attached to the lower surface 321_b of the first protrusion 320 overlaps overlap a trench region TR.

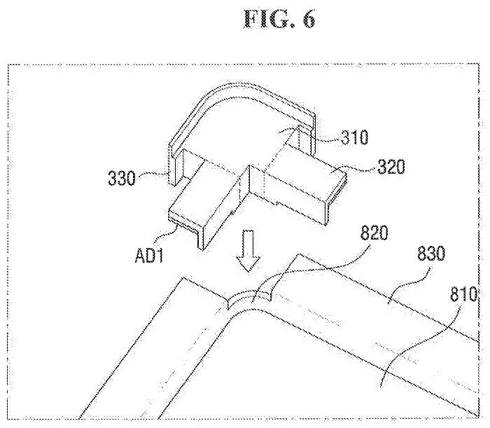

Referring to FIG. 6, according to an embodiment, a plurality of assembly members 300 to which the adhesive member AD1 is coupled are inserted into four corners of the bottom chassis 800. The assembly members 300 are vertically pressed and assembled such that the upper surface portion 321 of the first protrusion 320 and the support portion 830 of the bottom chassis 800 couple to overlap each other, and a side surface portion 322 of the first protrusion 320 and the sidewall 820 of the bottom chassis 800 couple to overlap each other. A new corner that is disposed inward as compared with each of four corners of the bottom chassis 800 is formed by the plurality of assembly members 300 coupled to the bottom chassis 800. That is, when the optical member 500 is disposed in the bottom chassis 800, the optical member 500 will be spaced a distance apart from the sidewall 820 of the bottom chassis 800.

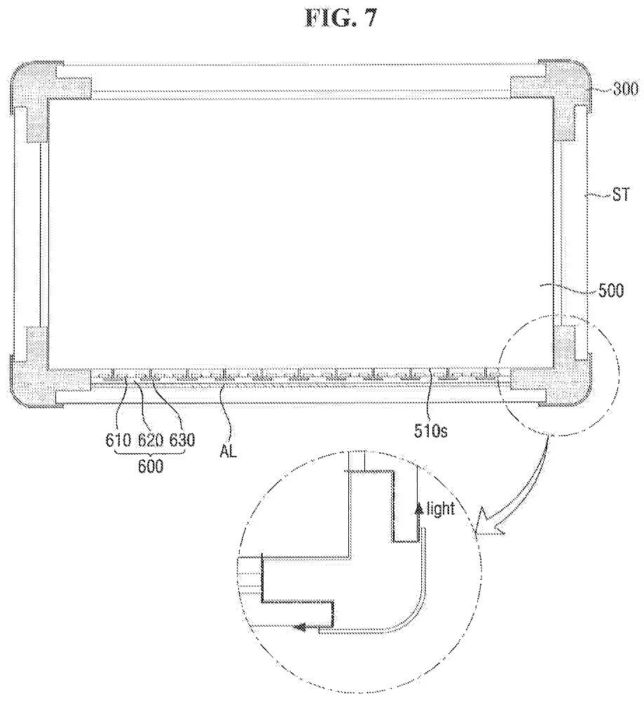

Next, referring to FIG. 7, according to an embodiment, the optical member 500 is inserted into the bottom chassis 800. When the assembly member 300 is coupled to each corner of the bottom chassis 800, the optical member 500 can be vertically pressed and assembled to be inserted into the bottom chassis 800. Here, four corners of the optical member 500 are disposed in contact with the new corners formed by the first protrusions 320 of the assembly members 300. Thus, a bonding force between the bottom chassis 800 and the optical member 500 is sufficiently secured.

According to an embodiment, the optical film 400 is attached onto the optical member 500 and completely overlaps the optical member 500. The optical member 500 and the optical film 400 are coupled to each other by an optical member coupling layer. The optical member coupling layer may be a film that has adhesive characteristics on both an upper surface and a lower surface thereof. For example, the optical member coupling layer may be a PSA, an OCA, or an OCR. The optical member coupling layer includes one of an acrylic resin or a silicone resin, etc.

According to an embodiment, a light source module 600 is inserted and faces one side of the optical member 500. For example, the light source module 600 is disposed adjacent to a light incidence surface 510s of a light guide plate 510 of the optical member 500. The light source module 600 includes a plurality of point light sources or linear light sources. The point light sources may be LED light sources 610. A plurality of LED light sources 610 are mounted on a printed circuit board 620. The LED light source 610 emits blue light. An aluminum bar AL is disposed between the printed circuit board 620 and the sidewall 820 of the bottom chassis 800. A plurality of support members 630 that support one surface of the optical member 500 are formed between the printed circuit board 620 and the aluminum bar AL. The plurality of support members 630 protrude toward the optical member 500 between the LED light sources 610 and are formed in contact with one surface of the optical member 500. Thus, it is possible to prevent the optical member 500 from being bent by gravity.

According to an embodiment, a spacer tape ST is attached onto the support portion 830 of the bottom chassis 800. The spacer tape ST includes a buffer member, a first adhesive layer disposed on one surface of the buffer member to attach the buffer member and the display panel 200, and a second adhesive layer disposed on the other surface of the buffer member to attach the buffer member and the bottom chassis 800. The spacer tape ST on the support portion 830 of the bottom chassis 800 is partially covered by the first protrusion 320 of the assembly member 300. As a result, a stepped portion is formed between the assembly member 300 and the bottom chassis 800. Since the display panel 200 attaches onto the assembly member 300 and the bottom chassis 800, the spacer tape ST has a thickness that is sufficient to compensate for the stepped portion between the assembly member 300 and the bottom chassis 800

According to an embodiment, in edge regions of the bottom chassis 800, both ends of the spacer tape ST are formed along boundaries between the body 310, and the first protrusion 320 and the second protrusion 330. Specifically, both ends of the spacer tape ST extend into and are surrounded by trench regions TR of the assembly member 300. Thereby, it is possible to prevent the spacer tape ST from detaching from the support portion 830 of the bottom chassis 800. In addition, light emitted from the light source module 600 propagates in all directions, such as the direction of the display panel 200 and the direction of the sidewall 820 of the bottom chassis 800. In this case, light propagating in the direction of the sidewall 820 of the bottom chassis 800, which can causes a light leak, is reflected three or more times by the trench region TR of the assembly member 300, and thus a phenomenon of light being unnecessarily visible outside the display device 1 can be considerably reduced.

Next, according to an embodiment, the display panel 200 is seated on the bottom chassis 800 to which the assembly member 300 is coupled. When the assembly member 300 is coupled to each corner of the bottom chassis 800, the display panel 200 is vertically pressed and assembled to be seated in the bottom chassis.

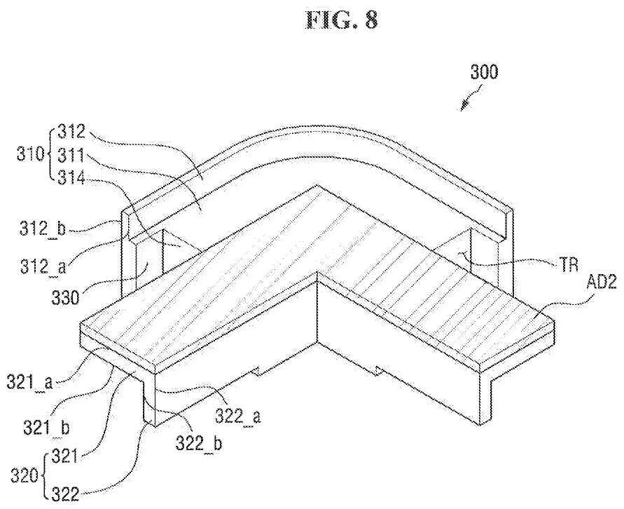

According to an embodiment, a corner surface of the display panel 200 may be disposed such that an inner side surface 312a of a sidewall portion 312 of the assembly member 300 is in contact therewith. In addition, referring now to FIG. 8, an adhesive member AD2 that couples one surface of the display panel 200 is disposed on a partial surface of the body 310 of the assembly member 300 and a first surface 321_a of the first protrusion 320. A planar shape of the adhesive member AD2 is that of an “L” shape. However, embodiments of the present disclosure are not limited thereto, and in other embodiments, the adhesive member AD2 is attached to an upper surface 311 of the body 300 of the assembly member 300 and an entire region of the first surface 321_a of the first protrusion 320. The first surface 321_a is coupled to a surface of the display panel 200 using the adhesive member AD2, such as a double-sided tape. However, embodiments of the adhesive member AD2 are not limited thereto, and in other embodiments, the adhesive member AD2 is an adhesive layer applied on the first surface 321_a. As a result, it is possible to secure a sufficient bonding force with the bottom chassis 800 to which the display panel 200 and the assembly member 300 are coupled.

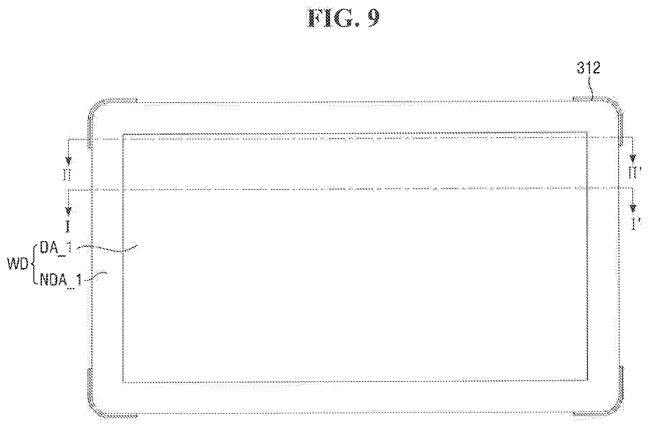

Referring to FIG. 9, according to an embodiment, the display panel 200 further includes a window WD. The window WD includes a transparent region DA_1 and a printed region NDA_1 that includes an opaque pigment that respectively overlap a display area DA and a non-display area NDA of the display panel 200. An air layer V is provided between the display panel 200 and the optical film 400, as shown in FIGS. 10 and 11. FIG. 10 is a cross-sectional view taken along line II-II′ of FIG. 9, and FIG. 11 is a cross-sectional view taken along line I-I′ of FIG. 9.

Hereinafter, other exemplary embodiments of an assembly member will be described. In the following exemplary embodiments, descriptions of the same configurations as those of the previously described exemplary embodiment will be omitted or simplified, and differences will be mainly described.

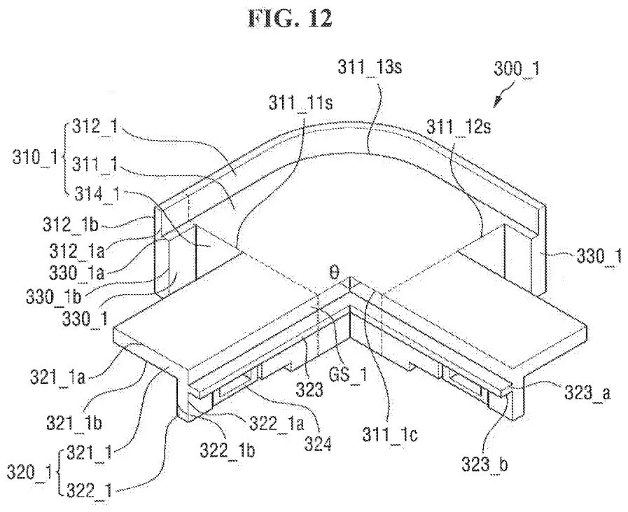

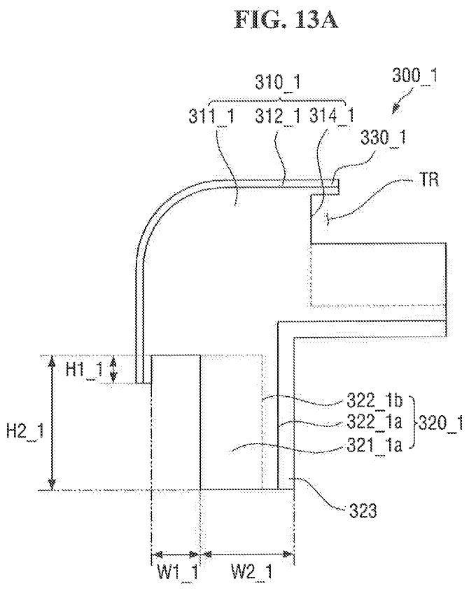

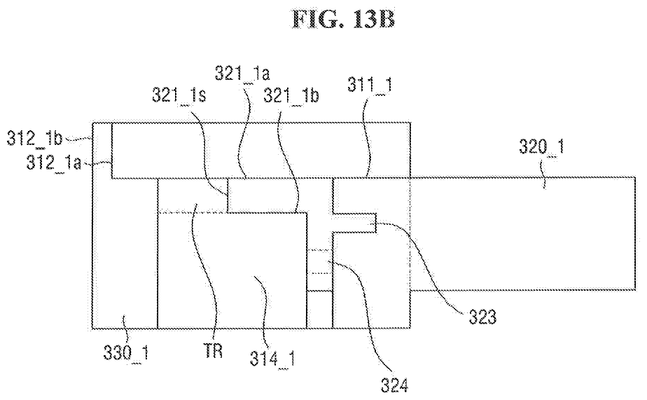

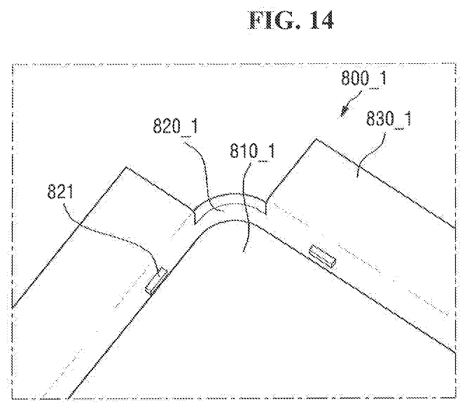

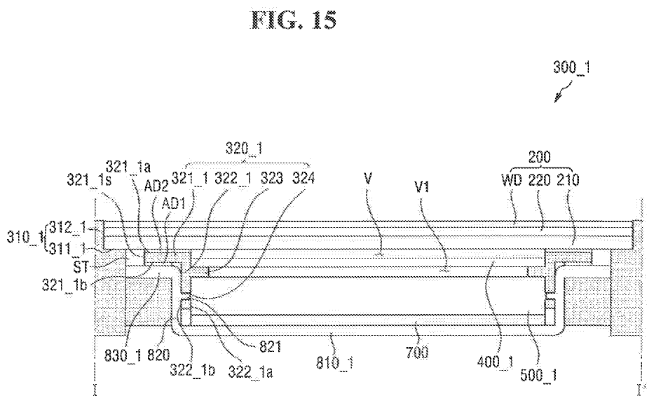

FIG. 12 is a perspective view of an assembly member according to another exemplary embodiment of FIG. 1. FIG. 13A is a plan view of an assembly member according to another exemplary embodiment. FIG. 13B is a side view of an assembly member according to another exemplary embodiment. FIG. 14 is a perspective view of a corner of a bottom chassis according to another exemplary embodiment. FIG. 15 is a cross-sectional view of a display device taken along line II-II′ of FIG. 9 according to another exemplary embodiment.

Referring to FIGS. 12 to 15, according to an embodiment, an assembly member 300_1 differs from the assembly member 300 shown in FIGS. 2A to 3B in that the assembly member 300_1 further includes a third protrusion 323 that protrudes from a support portion 311_1c of a body 310_1 of the assembly member 300_1 and a side surface portion 322 of a first protrusion 320_1, and a coupling hole 324 disposed in one region of the side surface portion 322_1 of the first protrusion 320_1.

More specifically, according to an embodiment, the assembly member 300_1 includes the body 310_1, two first protrusions 320_1, two second protrusions 330_1, and the third protrusion 323. For clarity of illustration, only one of each of the first protrusions 320_1 and second protrusions 330_1 is labeled. The body 310_1 of the assembly member 300_1 has one corner that forms a right angle. Each first protrusion 320_1 extends from one side of the body 310_1 and has a guide surface GS formed as a right angle θ in a plan view that guides the four corners of the optical member 500. To prevent the spacer tape ST from detaching, each second protrusion 330_1 extends from one side of the body 310 in directions perpendicular to each other and perpendicular to the extension direction of the first protrusion 320. The third protrusion 323 protrudes from the support portion 311_1c of the body 310_1 and the side surface portion 322_1 of the first protrusion 320_1.

According to an embodiment, the body 310_1 of the assembly member 300_1 includes an upper surface portion 311_1, a sidewall portion 312_1, a lower surface portion, and a side surface portion 314_1.

According to an embodiment, the upper surface portion 311_1 of the body 310_1 includes the support portion 311_c at a right angle in a plan view, and a peripheral portion 311_13s spaced apart from the support portion 311_c that has a first side 311_11s and a second side 311_12s which connect the support portion 311_c and the peripheral portion 311_13s. According to an exemplary embodiment, the body 310_1 has a rectangular shape in a plan view, the support portion 311_1c is a region bent to an inner side of the rectangular shape, and the peripheral portion 311_3s has a chamfered shape between two intersecting sides. The support 311_1c is in contact with a corner of the optical member 500 and supports the optical member 500 together with the side surface portion 322_1 of the first protrusion 320 to be described below. However, embodiments of the present disclosure are not limited thereto, and in other embodiments, a shape of the supporting portion 311_c can vary according to a shape of the corner of the optical member 500 disposed adjacent thereto. For example, the sidewall portion 312 may have a polygonal shape or an elliptical shape.

According to an embodiment, sidewall portion 312_1 of the body 310_1 extends upward from the peripheral portion 311_12s along the peripheral portion 311_12s. The sidewall portion 312_1 has an inner side surface 312_1a and an outer side surface 312_1b opposite to the inner side surface 312_1a. According to an exemplary embodiment, the sidewall portion 312_1 has a rounded corner in a plan view. To support the display panel 200, the inner side surface 312_1a is in contact with a corner of the display panel 200. When the display panel 200 has a frameless structure, the outer side surface 312_1b forms an exterior of a product. However, embodiments of the present disclosure are not limited thereto, and in other embodiments, a shape of the sidewall portion 312_1 can vary according to a shape of the corner of the display panel 200 disposed adjacent thereto. For example, the sidewall portion 312_1 may have a polygonal shape or an elliptical shape. A height of the sidewall portion 312_1 is greater than or equal to a thickness of the adjacent display panel 200.

According to an embodiment, the side surface portion 314_1 of the body 310_1 extends downward from the upper surface portion 311_1. A height of the side surface portion 314_1 is less than or equal to a height of the bottom chassis 800 coupled to the assembly member 300_1. According to an exemplary embodiment, the bottom surface 810_1 of the bottom chassis 800_1 has a rectangular shape in a plan view. The sidewall portion 820_1 that protrudes upward from the bottom surface 810_1 protrudes higher along the sides of the bottom chassis than in the four corner regions of the bottom chassis 800_1. The side surface portion 314_1 of the body 310_1 is disposed in contact with the sidewall portion 820_1 of the bottom chassis 800_1.

According to an embodiment, each first protrusion 320_1 of the assembly member 300_1 includes the upper surface portion 321_1 and the side surface portion 322_1.

According to an embodiment, the upper surface portions 321_1 of each first protrusion 320_1 respectively extend from a portion of the first side 310_11s and a portion of the second side 311_12s of the body 310_1. Each upper surface portion 321_1 has a first surface 321_1a and a second surface 321_1b opposite to the first surface 321_1a. The first surface 321_1a forms one coplanar surface with the upper surface portion 311_1. The first surface 321_1a and the upper surface portion 311_1 of the body 310_1 are in contact with a lower surface of the display panel 200. The second surface 321_1b is in contact with an upper surface of a support portion 830_1 of the bottom chassis 800_1. The second surface 321_1b couples to the support portion 830_1 of the bottom chassis 800_1 using an adhesive member AD1 such as a double-sided tape.

According to an embodiment, the side surface portion 322_1 of the first protrusion 320_1 extends downward from the upper surface portion 321_1, parallel to the extension direction of the second protrusions 330_1. The side surface portion 322_1 has a third surface 322_1a and a fourth surface 322_1b opposite to the third surface 322_1a. The third surface 322_1a forms one coplanar surface with the one surface of the support portion 311_1c. The third surface 322_1a and the surface of the support portion 311_1c are in contact with and overlap a corner surface of the optical member 500. The fourth surface 322_1b is in contact with and overlaps a surface of the sidewall portion 820_1 of the bottom chassis 800_1.

According to an embodiment, the coupling hole 324 is formed in a region of the side surface portion 322_1. The coupling hole 324 passes through the third surface 322_1a and the fourth surface 322_1b. The coupling hole 324 is illustrated in FIG. 12 as having a rectangular shape, but embodiments of the present disclosure are not limited thereto. In other embodiments, the coupling hole 324 may have one of a polygonal shape, an elliptical shape, or a circular shape, etc. A latch protrusion 821 formed in the sidewall portion 820_1 of the bottom chassis 800_1 to be described below is insertion-coupled to the coupling hole 324. Thus, the coupling between the assembly member 300_1 and the bottom chassis 800_1 is further strengthened. On the other hand, the side surface portion 322_1 further includes cutting regions at both sides of the coupling hole 324. Thus, the coupling hole 324 can move left and right, and thus, the latch protrusion 821 can be more easily coupled to the coupling hole 324.

According to an embodiment, the second protrusion 330_1 of the assembly member 300_1 extends from the upper surface portion 311_1 and the sidewall portion 312_1 of the body 310_1 at the first side 311_11s and the second side 310_12s and is parallel to the side surface portion 322_1 of the second protrusion 320_1. In the assembly member 300_1, trench regions TR are formed in spaces between the body 310_1, and the first protrusion 320-1 and the second protrusion 330_1 at the first side 311_11s and the second side 310_21s. A width W1 of the trench region TR is less than a width W2_1 of the upper surface portion 321_1 of the first protrusion 320_1, and a depth H1 of the trench region TR is less than a length H2 of the upper surface portion 321_1 of the first protrusion 320_1. The width W1 and the depth H1 of the trench region TR can be freely varied within the range to prevent the spacer tape ST from detaching from the support portion 830_1 of the bottom chassis 800_1.

According to an embodiment, the second protrusion 330_1 has a fifth surface 330_1a and a sixth surface 330_1b that extend downward from the fifth surface 330_1a. The fifth surface 330_1a of the second protrusion 330_1 forms one coplanar surface with the upper surface portion 311_1. The fifth surface 330_1a, first surface 321_1a and the upper surface portion 311_1 of the body 310_1 are in contact with a lower surface of the display panel 200. The sixth surface 330_1b of the second protrusion 330_1 is in contact with and overlaps a surface of the sidewall portion 820_1 of the bottom chassis 800_1.

According to an embodiment, the third protrusion 323 protrudes from a surface of the support portion 311_1c of the body 310_1 and the side surface portions 322_1 of the first protrusions 320_1. The third protrusion 323 has a seventh surface 323_a and an eighth surface 323_b opposite to the seventh surface 323_a. The seventh surface 323_a is in contact with a surface of an edge of the optical member 500_1. The eighth surface 323_b is in contact with a surface of an edge of the optical film 400_1. In addition, the optical film 400_1 couples to the third protrusion 323 using an adhesive member such as a double-sided tape or couples to the third protrusion 323 using a latch protrusion or a coupling hole. An air layer V1 is further provided between the optical film 400_1 and the optical member 500_1.

In concluding the detailed description, those skilled in the art will appreciate that many variations and modifications can be made to exemplary embodiments without substantially departing from the principles of the present disclosure. Therefore, exemplary embodiments of the disclosure are used in a generic and descriptive sense only and not for purposes of limitation.

What is claimed is:

1. A backlight assembly, comprising:
an optical member;
a bottom chassis that includes a bottom surface on which the optical member is disposed, a first sidewall portion that protrudes in a first direction from a side of the bottom surface, and a first support portion that protrudes from the first sidewall portion in a second direction that intersects the first direction; and
an assembly member that includes a body, and, protruding from the body, a first protrusion and a second protrusion,
wherein the second protrusion overlaps an outer surface of the first support portion.

2. The backlight assembly of claim 1, wherein the body includes a first upper surface portion and a first side surface portion that extends downward from the first upper surface portion,
wherein the first upper surface portion includes a corner portion that forms a right angle in a plan view, a peripheral portion spaced apart from the corner portion, and a first side and a second side that connect the corner portion and the peripheral portion.

3. The backlight assembly of claim 2, wherein the first protrusion extends from a portion of the first side and a portion of the second side and includes a second upper surface portion and a second side surface portion that extends downward from the second upper surface portion.

4. The backlight assembly of claim 3, wherein the first upper surface portion is coplanar with the second upper surface portion, and the first side surface portion is coplanar with the second side surface portion.

5. The backlight assembly of claim 4, wherein the optical member includes a plurality of corner portions, and each corner portion of the optical member is disposed in contact with the first side surface portion and the second side surface portion.

6. The backlight assembly of claim 3, wherein the assembly member further includes a third protrusion that extends from the second side surface portion of the first protrusion.

7. The backlight assembly of claim 6, wherein a lower surface of the third protrusion is in contact with an upper surface of the optical member.

8. The backlight assembly of claim 3, wherein the first sidewall portion of the bottom chassis further includes a latch stepped portion and the second side surface portion of the first protrusion includes a coupling hole that couples to the latch stepped portion.

9. The backlight assembly of claim 3, wherein the assembly member includes a second sidewall portion that extends upward from the peripheral portion.

10. The backlight assembly of claim 9, wherein the second protrusion extends from the second sidewall portion parallel to the second sidewall portion of the first protrusion.

11. The backlight assembly of claim 2, wherein the body includes a first lower surface portion opposite to the first upper surface portion, and the backlight assembly further includes a first adhesive member disposed between the first lower surface portion and the first support portion.

12. The backlight assembly of claim 1, further comprising a spacer tape disposed on the first support portion,
wherein both ends of the spacer tape are disposed along boundaries between the body, and the first protrusion and the second protrusion.

13. The backlight assembly of claim 1, wherein the optical member includes a light guide plate, a wavelength conversion layer disposed on the light guide plate, and a passivation layer that covers the wavelength conversion layer.

14. The backlight assembly of claim 1, further comprising an optical film disposed on the optical member.

15. The backlight assembly of claim 14, wherein the optical film includes at least one of a diffusion layer, a prismatic pattern layer, or a reflective polarizing layer.

16. A display device, comprising:
a display panel; and
a backlight assembly disposed on one surface of the display panel and that provides light to the display panel, wherein the backlight assembly includes an optical member; and
an assembly member that includes a body that includes a first upper surface portion, a first side surface portion that extends downward from the first upper surface portion, and a first protrusion and a second protrusion that protrude from the body,
wherein the first protrusion includes a second upper surface portion and a second side surface portion that extends downward from the second upper surface portion, and
wherein the optical member comprises a plurality of corner portions, and the corner portions of the optical member are disposed in contact with the first side surface portion and the second side surface portion.

17. The display device of claim 16, wherein the first protrusion extends from a portion of the first side and a portion of the second side, and wherein the first upper surface portion includes a corner portion that forms a right angle in a plan view, a peripheral portion spaced apart from the corner portion, and a first side and a second side that connect the corner portion and the peripheral portion.

18. The display device of claim 17, wherein the first upper surface portion is coplanar with the second upper surface portion, and the first side surface portion is coplanar with the second side surface portion.

19. The display device of claim 16, wherein the backlight assembly further comprises a bottom chassis that includes a bottom surface on which the optical member is disposed, a first sidewall portion that protrudes in a first direction from a side of the bottom surface, and a first support portion that protrudes from the first sidewall portion in a second direction that intersects with the first direction,
wherein the second protrusion overlaps an outer surface of the first support portion.

20. The display device of claim 17, wherein the assembly member includes a second sidewall portion that extends upward from the peripheral portion,
wherein the second sidewall portion is in contact with an edge of the display panel.
